(19) United States
(12) Patent Application Publication
(10) Pub. No.: US 2026/0138709 A1
(43) Pub. Date: May 21, 2026

(54) SELF-ENERGY STORAGE DEVICE AND METHOD APPLIED TO CONSTANT MOORING TENSION

(71) Applicant: TIANJIN RESEARCH INSTITUTE FOR WATER TRANSPORT ENGINEERING.M.O.T., Tianjin (CN)

(72) Inventors: Hanbao CHEN, Tianjin (CN); Songgui CHEN, Tianjin (CN); Yingni LUAN, Tianjin (CN); Wenjun SHEN, Tianjin (CN); Jiangnan CHEN, Tianjin (CN); Xingyu NIU, Tianjin (CN); Yingtao ZHU, Tianjin (CN); Ning GUAN, Tianjin (CN); Zhonghua TAN, Tianjin (CN); Zihao DUAN, Tianjin (CN)

(21) Appl. No.: 19/414,496

(22) Filed: Dec. 10, 2025

Related U.S. Application Data
(63) Continuation of application No. PCT/CN2025/123607, filed on Sep. 24, 2025.

(30) Foreign Application Priority Data
Nov. 19, 2024 (CN) 202411649596.8

(51) Int. Cl. B63B 21/20; B63B 21/00; F15B 1/027; F15B 1/04; F15B 1/26

(52) U.S. Cl. CPC B63B 21/20; F15B 1/027; F15B 1/04; F15B 1/26; B63B 2021/005

(57) ABSTRACT

A self-energy storage device and a method applied to constant mooring tension are provided. The device includes a hydraulic cylinder, a piston rod of the hydraulic cylinder is connected to one end of a cable; an energy storage module, including a first accumulator and a second accumulator, a volume of the second accumulator is greater than a volume of the first accumulator, and a maximum pressure of the first accumulator is set greater than a maximum pressure of the second accumulator. The first accumulator and the second accumulator are respectively connected to an oil chamber of the hydraulic cylinder via a hydraulic pipeline and are connected to each other via the hydraulic pipeline. The first accumulator and the second accumulator are configured to adjust an amount of hydraulic oil in the hydraulic cylinder for adjusting a pressure in the hydraulic cylinder.

### CROSS-REFERENCE TO RELATED APPLICATIONS

This application is a continuation of International Patent Application No. PCT/CN 2025/123607, filed on Sep. 24, 2025, and claims priority of Chinese Patent Application No. 202411649596.8, filed on Nov. 19, 2024. The contents of International Patent Application No. PCT/CN2025/123607 and Chinese Patent Application No. 202411649596.8 are hereby incorporated by reference.

### TECHNICAL FIELD

The present disclosure relates to the technical field of vessel mooring systems, and in particular to a self-energy storage device and a method applied to constant mooring tension.

### BACKGROUND

With the increasing size of vessels, the mooring safety of vessels has become one of the important factors constituting vessel accidents and risks. Vessel mooring mainly relies on equipment such as cables, winches, bollards, fairleads, and guide rollers for configuration and operation. After vessels become larger, the forces required to operate the equipment are very large, and the adjustment ranges of these forces vary significantly depending on different operation methods and capabilities. Reasonable equipment and mooring schemes may more effectively control these forces, reducing the risks and accidents during vessel mooring.

The equipment used by the vessel to control force on the cable mainly includes winch and bollard.

Among these, the control of forces on the cable by winches may be divided into three types: “manual”, that is, using the winch brake pads to lock firmly, and the force generated thereby hereinafter referred to as “braking force”; “automatic”, that is, using an oil pump to maintain constant tension on the cable, the force generated thereby hereinafter referred to as “constant tension”; and the force generated during the manual adjustment of the cable is referred to as “winching force”.

In comparison, the magnitude of “constant tension” is determined by the oil pump and may be adjusted by regulating the output power of the oil pump; the characteristics of “constant tension” are that it provides constant tension to the cable when the vessel is stationary, and adjusts the length of the cable to maintain vessel stability when the vessel moves forward, backward, or outward.

However, methods in the prior art for providing constant tension to the cable mostly involve external energy supply, that is, using a hydraulic pump station. This method requires additional consumption of fuel or electrical energy, and simultaneously, the operation of the hydraulic pump station generates noise and vibration, causing environmental impact.

Furthermore, due to the limited adjustment range of existing constant tension systems and insufficient response speed caused by hysteresis effects in hydraulic system controllers and sensors, when the vessel's movement amplitude or external force changes exceed this range, the system may fail to adjust the tension and length of the cable in a timely and effective manner.

Therefore, it is necessary to design a method and a device capable of automatically storing and utilizing vessel energy, so that the cable may have a large elongation (2-3 meters) and maintain stable tension under large forces (30-50 tons), while reducing energy consumption.

### SUMMARY

To solve the above technical problems, the present disclosure provides a self-energy storage device and a method applied to constant mooring tension. By storing the energy generated by the vessel's own movement, it solves the problems of additional energy consumption required for providing constant tension in vessel mooring, and insufficient tension and elongation of the cable.

In a first aspect, a first object of the present disclosure is to provide a self-energy storage device applied to constant mooring tension, including:
a hydraulic cylinder, where a piston rod of the hydraulic cylinder is connected to one end of a cable;
an energy storage module, where the energy storage module includes a first accumulator and a second accumulator, a volume of the second accumulator is greater than a volume of the first accumulator, and a maximum pressure of the first accumulator is set greater than a maximum pressure of the second accumulator;
the first accumulator and the second accumulator are respectively connected to an oil chamber of the hydraulic cylinder via a hydraulic pipeline; and the first accumulator and the second accumulator are connected to each other via the hydraulic pipeline; and
the first accumulator and the second accumulator are configured to adjust an amount of hydraulic oil in the hydraulic cylinder for adjusting a pressure in the hydraulic cylinder, so as to maintain a tension in the cable constant near a preset value during operation.

In an embodiment, the energy storage module further includes:
a first check valve disposed between the first accumulator and the hydraulic cylinder and configured to control whether the hydraulic oil in the oil chamber is transmitted to the first accumulator;
a second check valve disposed between the second accumulator and the hydraulic cylinder and configured to control whether the hydraulic oil in the second accumulator is transmitted to the oil chamber;
a first relief valve disposed on the hydraulic pipeline between the first accumulator and the second accumulator and configured to control a maximum pressure of the first accumulator;
a second relief valve connected to the second accumulator via the hydraulic pipeline and configured to control the maximum pressure of the second accumulator; and
an oil tank connected to the second relief valve for storing the hydraulic oil from the second accumulator.

In an embodiment, the device further includes:
a third check valve disposed on the hydraulic pipeline between the oil tank and the oil chamber and configured for controlling whether the hydraulic oil in the oil tank is transmitted to the oil chamber.

In an embodiment, the second relief valve is provided on the hydraulic pipeline between the second accumulator and the oil chamber, the second relief valve is configured for stabilizing a pressure at an outlet of the second accumulator.

In an embodiment, the first relief valve is a pilot-operated relief valve, and the second relief valve is a direct-acting relief valve.

In an embodiment, the device is fixed to a vessel via bolts.

In a second aspect, a second object of the present disclosure is to provide a self-energy storage method applied to constant mooring tension, including:
S1: connecting the hydraulic cylinder to the cable, and installing the device on the vessel;
S2: when the cable is stretched, the piston rod moves outward, and hydraulic oil flows from the oil chamber into the first accumulator;
S3: if the cable does not continue to stretch, proceeding to S4; and if the cable continues to stretch, when a pressure in the first accumulator reaches a set maximum pressure, the hydraulic oil flows from the first accumulator into the second accumulator for storage, and a tension of the cable is a first preset value; when a pressure in the second accumulator reaches a set maximum pressure, the hydraulic oil flows from the second accumulator into the oil tank.
S4: when the cable contracts, the piston rod moves inward, and the hydraulic oil flows from the second accumulator into the oil chamber;
S5: if the cable does not continue to contract, directly proceeding to S6; and if the cable continues to contract, when the second accumulator does not contain the hydraulic oil, the hydraulic oil in the oil chamber flows into the oil tank; and
S6: cyclically performing the steps S2 to S5.

The embodiments of the present disclosure have the following technical effects.

The present disclosure, by configuring the first accumulator as a high-pressure accumulator and the second accumulator as a low-pressure accumulator, and providing check valves, relief valves, etc., facilitates energy interaction between the hydraulic cylinder and the two accumulators, capable of storing energy generated by the mooring vessel's own movement; and by setting the maximum pressure value in the first accumulator, the maximum tension during rope stretching may be determined, and by setting the maximum pressure value in the second accumulator, the maximum tension during rope retraction may be determined, better meeting actual requirements.

When the cable is subjected to a large force, the first accumulator allows the tension to maintain a stable small variation, and the cable also has a large elongation, making the vessel mooring more stable; and when the cable is loosened, the second accumulator provides a tension to the cable, preventing unstable shaking caused by instantaneous complete loosening.

Utilizing the vessel's own energy for power supply reduces energy loss during energy transmission and conversion in the hydraulic system, thereby improving overall energy efficiency and enabling more environmentally friendly and sustainable energy utilization. In addition, this approach eliminates the need for external energy supply such as from hydraulic pump stations, reduces maintenance requirements for hydraulic pump stations, lowers environmental pollution, and avoids noise and vibration generated during operation of hydraulic pump stations.

Furthermore, in some special environments (such as remote areas, polar regions), it may be difficult to obtain external energy, and the present disclosure may enhance the vessel's adaptability when mooring in these environments.

### BRIEF DESCRIPTION OF THE DRAWINGS

To more clearly illustrate the specific embodiments of the present disclosure or the technical schemes in the prior art, the drawings required for describing the specific embodiments or the prior art will be briefly introduced below. Apparently, the drawings in the following description pertain to some embodiments of the present disclosure, and other drawings may be obtained by those of ordinary skill in the art based on these drawings without creative effort.

FIG. 1 is a schematic structural diagram of a self-energy storage device applied to constant mooring tension according to an embodiment of the present disclosure.

FIG. 2 is a schematic structural diagram of a first check valve, a second check valve, or a third check valve according to an embodiment of the present disclosure.

FIG. 3 is a schematic structural diagram of a first relief valve according to an embodiment of the present disclosure.

FIG. 4 is a schematic structural diagram of a second relief valve according to an embodiment of the present disclosure.

FIG. 5 is a schematic structural diagram of a hydraulic cylinder according to an embodiment of the present disclosure.

FIG. 6 is a schematic structural diagram of a first accumulator or a second accumulator according to an embodiment of the present disclosure.

FIG. 7 is a schematic diagram illustrating variation of tension magnitude of a cable with wave fluctuations according to an embodiment of the present disclosure.

FIG. 8 is a flow chart of a self-energy storage method applied to constant mooring tension according to the present disclosure.

### DETAILED DESCRIPTION OF THE EMBODIMENTS

To make the objectives, technical solutions, and advantages of the present disclosure clearer, the technical solutions of the present disclosure will be described clearly and completely below. Apparently, the described embodiments are only a part of the embodiments of the present disclosure, and not all of them. All other embodiments obtained by a person of ordinary skill in the art based on the embodiments of the present disclosure without creative efforts shall fall within the protection scope of the present disclosure.

### Embodiment 1

The following content is first explained.

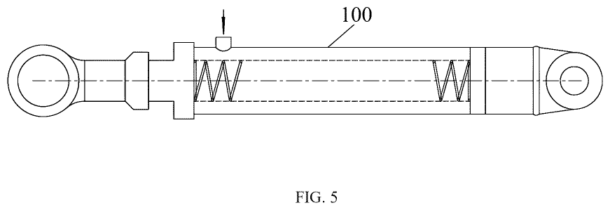

Referring to FIG. 5, a hydraulic cylinder 100 is an actuating element in a hydraulic system, which may convert hydraulic energy into mechanical energy. It includes a sealed oil chamber formed by a steel cylinder and a cylinder cover, a piston rod displaced within the oil chamber, and an exhaust device.

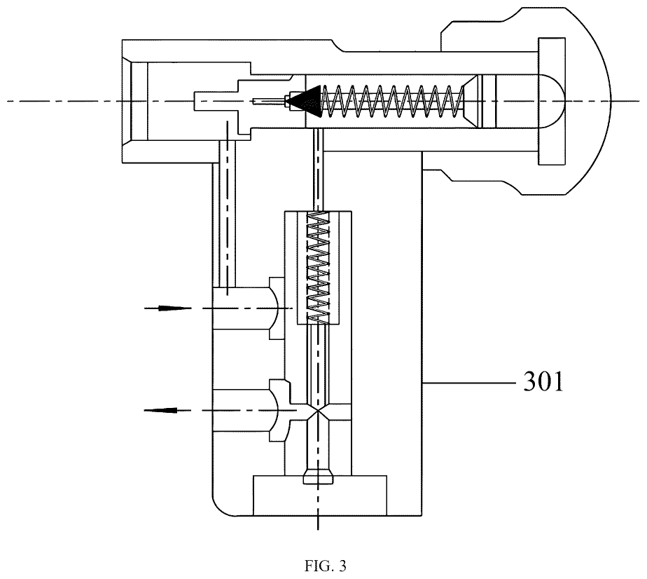

Referring to FIG. 3, a pilot-operated relief valve (i.e., a first relief valve 301) includes two parts: a main valve and a pilot valve. The main valve is a valve that opens and closes via medium pressure, while the pilot valve controls the opening and closing of the main valve via pressure changes in a pilot oil circuit. The pilot oil circuit includes two control ports and a pilot chamber, and the structure is relatively complex. When the medium pressure is lower than the set valve pressure, the valve closes, and the medium may not flow through the valve; when the medium pressure reaches the set valve pressure, the pilot valve opens first, controlling the opening of the main valve via pressure changes in the pilot oil circuit, so that the medium to flow through. When the medium pressure decreases, the pressure in the pilot oil circuit also decreases, and the main valve closes. This working principle gives the pilot-operated relief valve the characteristics of fast response and stable performance.

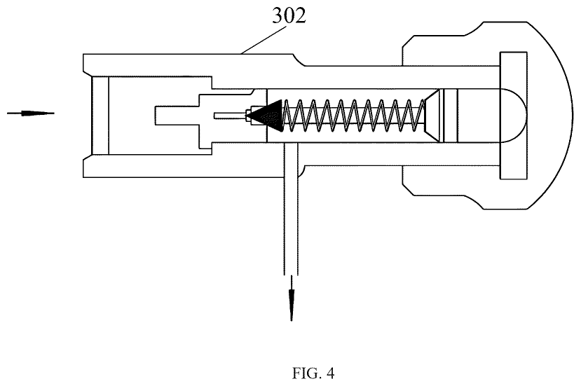

Referring to FIG. 4, a direct-acting relief valve (i.e., a second relief valve 302) mainly includes a valve body and a valve core. Inside the valve body, there is an adjustment hole and an adjustment screw; the pressure of an adjustment spring is changed by the adjustment screw, thereby adjusting the displacement of the valve core and controlling the flow rate. The control of the overflow rate is achieved by adjusting the displacement of the valve core. When pressure oil enters the valve body, the pressure acts on the valve core; when the pressure exceeds the force exerted by the adjustment screw, the valve core opens, and the oil flows out from an overflow hole to achieve pressure regulation. When the pressure decreases, the spring on the adjustment screw closes the valve core.

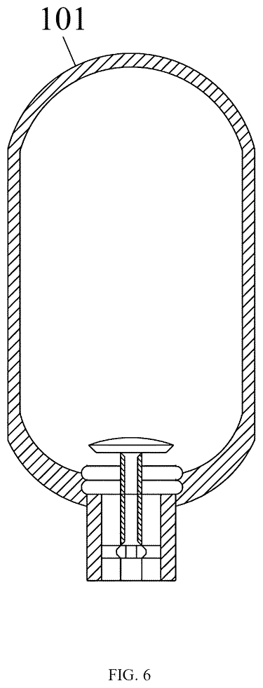

Referring to FIG. 6, a main function of the accumulators 101, 102 is to convert the energy in the system into compression energy or potential energy for storage at an appropriate time; when the system requires it, the energy is released in the form such as hydraulic or pneumatic pressure to supplement the system energy.

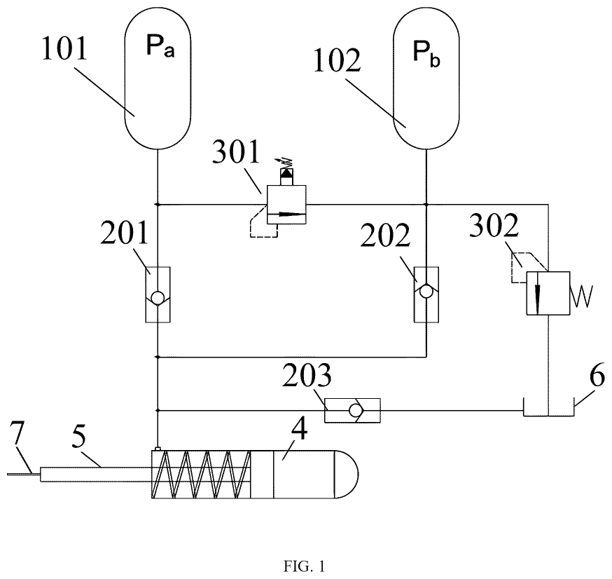

FIG. 1 is a schematic diagram of a self-energy storage device applied to constant mooring tension according to an embodiment of the present disclosure. Referring to FIG. 1, the device of the present disclosure includes a hydraulic cylinder 100, and an energy storage module.

The piston rod 5 of the hydraulic cylinder 100 is connected to one end of a cable 7, and as the tension in the cable changes, the piston rod 5 correspondingly extends or retracts; it may be noted that the piston rod 5 in the hydraulic cylinder has an automatic return function.

The energy storage module includes a first accumulator 101 and a second accumulator 102, a volume of the second accumulator 102 is greater than a volume of the first accumulator 101, and a maximum pressure of the first accumulator 101 is set greater than a maximum pressure of the second accumulator 102. Specifically, the first accumulator 101 may be regarded as a high-pressure accumulator, and the second accumulator 102 may be regarded as a low-pressure accumulator.

The first accumulator 101 and the second accumulator 102 are respectively connected to an oil chamber 4 of the hydraulic cylinder via a hydraulic pipeline; the first accumulator 101 and the second accumulator 102 are connected to each other via the hydraulic pipeline. By adjusting an amount of hydraulic oil in the hydraulic cylinder via the first accumulator 101 and the second accumulator 102, a pressure in the hydraulic cylinder is adjusted, such that during operation a tension in the cable is maintained constant within a preset value.

During vessel mooring, the vessel's rocking causes repeated stretching and contraction of the cable. This cycle may be relatively short, so the capacity of the first accumulator 101 is made smaller, allowing the tension to quickly reach the maximum when the cable is stretched, while repeatedly transferring energy to the second accumulator 102; the volume of the second accumulator 102 is larger, so its ability to smooth pressure fluctuations is stronger, allowing it to slowly reduce the tension of the cable, and avoiding drastic fluctuations in the pressure in the oil chamber 4.

In the present disclosure, the tension is calculated by the following formula:

F=P×S,

where P represents the pressure in the oil chamber, and S represents the piston surface area of the piston rod. S is a constant value. Thus, the tension is constant by maintaining P as a constant value.

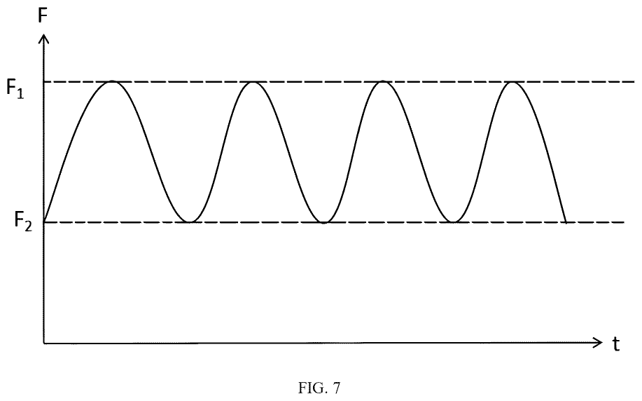

Based on the above principle, during operation of the self-energy storage device, referring to FIG. 7, the cable stretches or contracts with wave fluctuations, thereby driving the piston rod 5 to repeatedly extend and retract. The relatively high maximum pressure of the first accumulator 101 primarily receives the hydraulic oil from the oil chamber 4 when the cable is stretched, reducing the pressure in the oil chamber 4 and stabilizing it near the maximum pressure of the first accumulator 101, thereby maintaining the tension in the cable near a first preset value F₁. However, the relatively low maximum pressure of the second accumulator 102 primarily causes it to supply hydraulic oil when the cable contracts, increasing the pressure in the oil chamber 4 and stabilizing it near the maximum pressure of the second accumulator 102, thereby maintaining the tension in the cable near a second preset value F₂. The device as a whole may serve the function of storing energy, thereby achieving the purpose of self-power supply.

It may be noted that the maximum pressures of the first accumulator 101 and the second accumulator 102 may be set according to actual needs. Therefore, the maximum tension during rope stretching is maintained at the tension corresponding to the pressure set for the first accumulator 101, that is, near the first preset value F₁. Similarly, the maximum tension during rope contraction is maintained near the tension corresponding to the pressure set for the second accumulator 102, that is, near the second preset value F₂.

When the piston rod 5 continuously retracts, that is, when the cable is not operating, the tension will gradually decrease from F₂ to 0. Furthermore, based on FIG. 7, the tension exhibits stable small variations during both stretching and retraction processes, which are generated due to the structural limitations of components such as accumulators and valves, but the range of variation is small and does not affect the overall tension trend.

### Embodiment 2

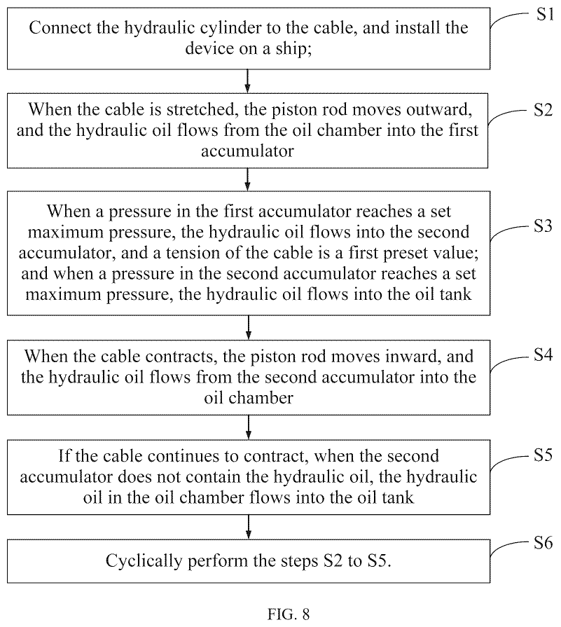

Based on the device in Embodiment 1, as shown in FIG. 8, a self-energy storage method applied to constant mooring tension is provided, including the following steps:
S1: the hydraulic cylinder is connected to the cable, and the device is installed on the vessel;
S2: when the cable is stretched, the piston rod 5 moves outward, and hydraulic oil flows from the oil chamber 4 into the first accumulator 101;
S3: if the cable does not continue to stretch, the step S4 is performed; if the cable continues to stretch, when a pressure in the first accumulator 101 reaches a set maximum pressure, the hydraulic oil flows from the first accumulator 101 into the second accumulator 102 for storage, and the tension of the cable is a first preset value; when a pressure in the second accumulator 102 reaches a set maximum pressure, the hydraulic oil flows from the second accumulator 102 into the oil tank.
S4: when the cable contracts, the piston rod 5 moves inward, and the hydraulic oil flows from the second accumulator 102 into the oil chamber 4;
S5: if the cable does not continue to contract, the step S6 is performed; if the cable continues to contract, when there is no hydraulic oil in the second accumulator 102, the hydraulic oil in the oil chamber 4 flows into the oil tank 6; and
S6: the steps S2 to S5 are cyclically performed.

### Embodiment 3

Based on the content of Embodiment 1, the energy storage module further includes a first check valve 201, a second check valve 202, a first relief valve 301, a second relief valve 302, and an oil tank 6.

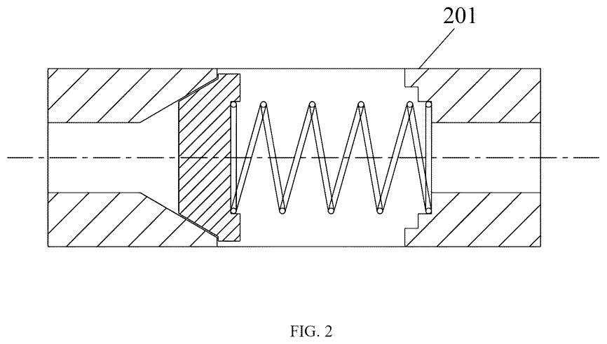

The first check valve 201 is disposed between the first accumulator 101 and the hydraulic cylinder, and is configured to control whether hydraulic oil in the oil chamber 4 is transmitted to the first accumulator 101; referring to FIG. 2, when the pressure in the oil chamber 4 is greater than the pressure in the first accumulator 101, the first check valve 201 opens and functions.

The second check valve 202 is disposed between the second accumulator 102 and the hydraulic cylinder, and is configured to control whether the hydraulic oil in the second accumulator 102 is transmitted to the oil chamber 4; when the pressure in the oil chamber 4 is less than the pressure in the second accumulator 102, the second check valve 202 opens and functions.

The first relief valve 301 is disposed on the hydraulic pipeline between the first accumulator 101 and the second accumulator 102, and is configured to control a maximum pressure P₁ of the first accumulator 101; the first relief valve is selected as the pilot-operated relief valve based on the functional effect of the first relief valve. First, the pressure of the pilot-operated relief valve is set via an adjustment nut; when the pressure at the end of the pilot-operated relief valve connected to the first accumulator 101 exceeds the set pressure, the pilot-operated relief valve opens; the first relief valve may be configured according to actual requirements.

The second relief valve 302 is connected to the second accumulator 102 via the hydraulic pipeline, is configured to control a maximum pressure in the second accumulator 102; the second relief valve may be the direct-acting relief valve, which is more suitable for low-pressure and small-flow conditions and has high sensitivity; the second relief valve may be configured according to actual requirements.

The oil tank 6 is connected to the second relief valve 302, for storing hydraulic oil from the second accumulator 102; by providing the external oil tank, the hydraulic oil is supplied to the oil chamber 4 for replenishment when the pressures in the second accumulator 102 and the oil chamber 4 are unbalanced.

A third check valve 203 is provided on the hydraulic pipeline between the oil tank 6 and the oil chamber 4. The third check valve 203 is configured for controlling whether to transmit hydraulic oil from the oil tank 6 to the oil chamber 4. The first check valve, the second check valve, and third check valve have the same structure.

The second relief valve 302 is provided on the hydraulic pipeline between the second accumulator 102 and the oil chamber 4. The function of the second relief valve 302 is to achieve pressure stability by setting the threshold pressure: when the system pressure is lower than the set value, the valve remains closed; and when the pressure exceeds the threshold, the valve core is opened to discharge the excess hydraulic oil, thus releasing the excess pressure and keeping the system within the set pressure range. Therefore, the second relief valve 302 may stabilize the pressure at the outlet of the second accumulator 102. When the tension in the cable is less than a certain value, the third check valve 203 opens while the second check valve closes, making the energy storage function of the second accumulator 102 more pronounced.

The present disclosure provides two accumulators connected to the hydraulic cylinder. The accumulators store energy based on the hydraulic principles. The two accumulators are set with different volumes and different maximum pressures via relief valves, storing energy generated by vessel movement, and ensuring that the tension in the cable remains constant during extension and retraction without external energy supply.

Based on the configuration of the above device structure, the actual usage process includes the following steps.

Step 1: the hydraulic cylinder is connected to the cable, and the device is installed on the vessel.

Step 2: when the cable is stretched, the piston rod moves outward, the oil pressure on the oil chamber side of the first check valve 201 is greater than that on the first accumulator side, the first check valve 201 opens, and hydraulic oil enters the first accumulator 101.

If the cable continues to elongate, the pulling force gradually increases, the tension gradually increases, and the hydraulic oil in the first accumulator 101 increases until it reaches the set maximum pressure P₁. At this point, if the cable continues to elongate, hydraulic oil needs to continue transferring from the oil chamber 4 to the first accumulator 101; the first relief valve 301 opens, and hydraulic oil from the first accumulator 101 enters the second accumulator 102. At this time, the total amount of hydraulic oil in the first accumulator 101 remains unchanged, and the tension in the cable is F₁.

If the cable continues to elongate, it may be elongated to the maximum extent until the hydraulic oil fills the second accumulator 102, causing the second accumulator 102 to reach the set maximum pressure P₂; if the pressure in the second accumulator 102 exceeds the set maximum pressure, the second relief valve 302 opens, and hydraulic oil enters the oil tank 6, keeping the total amount of hydraulic oil in the second accumulator 102 unchanged. At this time, the tension in the cable is still F₁.

Step 3: when the cable begins to contract, the piston rod 5 automatically moves inward. At this time, the oil pressure at the oil chamber side of the first check valve 201 is less than that at the first accumulator side, the first check valve 201 closes, the oil pressure in the first accumulator 101 stabilizes near P₁, and the first relief valve 301 closes, and similarly the second relief valve 302 closes. And, the oil pressure at the oil chamber side of the second check valve 202 is less than that at the second accumulator 102 side, the second check valve 202 opens, and the hydraulic oil flows from the second accumulator 102 into the oil chamber 4.

The tension magnitude at this time is F₂, the hydraulic oil from the oil tank 6 does not enter the oil chamber 4 because the pressure in the second accumulator 102 is greater than the pressure in the oil tank 6. The pressure in the oil tank 6 is atmospheric pressure. The amount of hydraulic oil in the oil tank 6 is greater than the amount required for full retraction of the piston rod 5 in the oil chamber 4, and must also satisfy a basic oil tank level, which may be approximately 2 to 3 times the amount of hydraulic oil required for full retraction of the piston rod 5.

If the cable continues to contract, the oil pressure in the second accumulator 102 decreases, and the tension in the cable gradually becomes less than F₂, until the hydraulic pressure in the second accumulator 102 is less than or equal to the hydraulic pressure in the oil chamber 4, then the second check valve 202 closes. At this time, hydraulic oil from the oil tank 6 continues to enter the oil chamber to compensate for the negative pressure generated in the oil chamber; or the cable directly stretches and proceeds to the next step 4.

It may be noted that when the second relief valve is provided, when the tension in the cable is less than a set value, the second check valve 202 is in a closed state, and at this time the third check valve 203 is in an open state; when the tension in the cable is greater than the set value, the second relief valve and the second check valve 202 open, allowing hydraulic oil from the second accumulator 102 to enter the oil chamber 4.

Step 4: When the cable is stretched again, the piston rod moves outward, and the oil pressure in the oil chamber 4 decreases.

The oil pressure on the oil chamber side of the first check valve 201 is greater than that on the first accumulator side, the first check valve 201 opens, and the hydraulic oil enters the first accumulator 101. At this time, the hydraulic pressure in the first accumulator 101 is close to F₁, so the first relief valve 301 opens, and the hydraulic oil flows from the first accumulator 101 into the second accumulator 102; if the hydraulic pressure in the second accumulator 102 is close to F₂, the second relief valve 302 opens, and the hydraulic oil enters the oil tank 6. At this time, the tension of the cable is F₁.

Step 5: When the cable contracts again, the step 2 is performed.

Based on the above technical solutions, the present disclosure solves the problems of additional energy consumption required for providing constant tension in vessel mooring and insufficient tension and elongation of the cable by storing energy generated by the vessel's own movement.

It may be noted that the terminology used herein is for the purpose of describing particular embodiments only and is not intended to limit the scope of the present disclosure. As used in the specification of the present disclosure, unless the context clearly indicates otherwise, the singular forms “a”, “an”, and “the” are intended to include the plural forms as well. The term “include”, “have” or any other variation thereof is intended to cover a non-exclusive inclusion, such that a process, method, article, or apparatus that includes a list of elements includes not only those elements but may also include other elements not expressly listed or inherent to such process, method, article, or apparatus. An element preceded by “includes a . . . ” does not, without more constraints, preclude the existence of additional identical elements in the process, method, article, or apparatus that includes the element.

It may also be noted that the orientation or positional relationships indicated by terms such as “center”, “upper”, “lower”, “left”, “right”, “vertical”, “horizontal”, “inner”, “outer” are based on the orientation or positional relationships shown in the drawings, and are merely for the convenience of describing the present disclosure and simplifying the description, rather than indicating or implying that the referred apparatus or element must have a specific orientation, be constructed and operated in a specific orientation, and thus may not be construed as limiting the disclosure. Unless otherwise expressly specified and defined, terms such as “mounted”, “connected”, and “coupled” should be interpreted broadly. For example, “connected” may be a fixed connection, a detachable connection, or an integral connection; may be a mechanical connection, or an electrical connection; may be a direct connection, or an indirect connection via an intermediary, or an internal connection between two elements. Those of ordinary skill in the art may understand the specific meanings of the above terms in the present disclosure based on specific situations.

Finally, it may be noted that: the above embodiments are only used to illustrate the technical schemes of the present disclosure, and not to limit them; although the present disclosure has been described in detail with reference to the foregoing embodiments, those of ordinary skill in the art should understand that: they may still modify the technical solutions described in the foregoing embodiments, or perform equivalent replacements for some or all of the technical features; and these modifications or replacements do not make the essence of the corresponding technical solutions depart from the scope of the technical solutions of the embodiments of the present disclosure.

What is claimed is:

1. A self-energy storage device applied to constant mooring tension, comprising:
a hydraulic cylinder, wherein a piston rod of the hydraulic cylinder is connected to one end of a cable; and
an energy storage module, wherein the energy storage module comprises a first accumulator and a second accumulator, a volume of the second accumulator is greater than a volume of the first accumulator, and a maximum pressure of the first accumulator is set greater than a maximum pressure of the second accumulator;
wherein the first accumulator and the second accumulator are respectively connected to an oil chamber of the hydraulic cylinder via a hydraulic pipeline, and the first accumulator and the second accumulator are connected to each other via the hydraulic pipeline;
the first accumulator and the second accumulator are configured to adjust an amount of hydraulic oil in the hydraulic cylinder for adjusting a pressure in the hydraulic cylinder, so as to maintain a tension in the cable constant near a preset value during operation; and
the energy storage module further comprises:
a first check valve disposed between the first accumulator and the hydraulic cylinder and configured to control whether the hydraulic oil in the oil chamber is transmitted to the first accumulator;
a second check valve disposed between the second accumulator and the hydraulic cylinder and configured to control whether the hydraulic oil in the second accumulator is transmitted to the oil chamber;
a first relief valve disposed on the hydraulic pipeline between the first accumulator and the second accumulator, and configured to control the maximum pressure of the first accumulator;
a second relief valve connected to the second accumulator via the hydraulic pipeline and configured to control the maximum pressure of the second accumulator; and
an oil tank connected to the second relief valve for storing the hydraulic oil from the second accumulator.

2. The self-energy storage device applied to constant mooring tension according to claim 1, further comprising:
a third check valve disposed on the hydraulic pipeline between the oil tank and the oil chamber, wherein the third check valve is configured to control whether the hydraulic oil in the oil tank is transmitted to the oil chamber.

3. The self-energy storage device applied to constant mooring tension according to claim 1, wherein the second relief valve is provided on the hydraulic pipeline between the second accumulator and the oil chamber, and the second relief valve is configured for stabilizing a pressure at an outlet of the second accumulator.

4. The self-energy storage device applied to constant mooring tension according to claim 1, wherein the first relief valve is a pilot-operated relief valve, and the second relief valve is a direct-acting relief valve.

5. The self-energy storage device applied to constant mooring tension according to claim 1, wherein the self-energy storage device is fixed to a vessel via bolts.

6. A self-energy storage method applied to constant mooring tension, implemented based on the self-energy storage device according to claim 1, wherein the method comprises following steps:
S1: connecting the hydraulic cylinder to the cable, and installing the self-energy storage device on a vessel;
S2: when the cable is stretched, the piston rod moves outward, and the hydraulic oil flows from the oil chamber into the first accumulator;
S3: if the cable does not continue to stretch, proceeding to step S4; and if the cable continues to stretch, when a pressure in the first accumulator reaches the maximum pressure of the first accumulator, the hydraulic oil flows from the first accumulator into the second accumulator for storage, and a tension of the cable is a first preset value; and when a pressure in the second accumulator reaches the maximum pressure of the second accumulator, the hydraulic oil flows from the second accumulator into the oil tank;
S4: when the cable contracts, the piston rod moves inward, and the hydraulic oil flows from the second accumulator into the oil chamber;
S5: if the cable does not continue to contract, directly proceeding to step S6; and if the cable continues to contract, when the second accumulator does not contain the hydraulic oil, the hydraulic oil in the oil chamber flows into the oil tank; and
S6: cyclically performing the steps S2 to S5.
